(19) United States
(12) Patent Application Publication
(10) Pub. No.: US 2007/0289646 A1
(43) Pub. Date: Dec. 20, 2007

(54) Mixer valve for liquids, particularly for electrical domestic appliances

(75) Inventor: Paolo Ravedati, Moncalieri (Torino) (IT)

Correspondence Address: SUGHRUE MION, PLLC, 2100 PENNSYLVANIA AVENUE, N.W., SUITE 800, WASHINGTON, DC, 20037, US

(73) Assignee: ELBI INTERNATIONAL S.P.A.

(21) Appl. No.: 11/455,682

(22) Filed: Jun. 20, 2006

(51) Int. Cl. F16K 11/22

(52) U.S. Cl. 137/606

(57) ABSTRACT

The mixer valve includes a valve body with at least a first and a second inlet for connection to a source of hot water and to a source of cold water respectively, and an outlet manifold. This body is associated with a first electrically operated shut-off valve interposed between the first inlet and the outlet manifold, and a second and third electrically operated shut-off valve, in parallel hydraulically with each other, between the second inlet and the outlet manifold. A control unit is provided to set the valves selectively to one of a plurality of predetermined modes, to provide a flow of water at the outlet manifold with a temperature at a corresponding predetermined level.

The present invention relates to a mixer valve for liquids, particularly for use in electrical domestic appliances where water is to be provided at different temperatures, as for example in washing machines or dishwashers.

The object of the present invention is to provide an improved mixer valve for liquids, capable of making flows of water available at various temperatures to meet the widest range of operating requirements.

This and other objects are achieved according to the invention with a mixer valve for liquids comprising

a valve body having

at least a first and a second inlet for connection to a source of hot water and a source of cold water respectively, and

an outlet manifold;

a first, a second and a third electrically operated shut-off valve, of which

the first valve is interposed between the first passage and the outlet manifold;

the second and third valves are hydraulically connected in parallel between the second inlet and the outlet manifold so that, when they are open, they allow the passage of a first and second flow of cold water respectively from the second inlet to the outlet manifold, the first flow of cold water having a flow rate less than or equal to the flow rate of the second flow of cold water;

control means for setting the said valves selectively to one of the following modes:

a) the first and second valves are open, while the third valve is closed;

b) the first, second and third valves are open simultaneously; and

c) the third valve is open, while the first and second valves are closed.

In a preferred embodiment, the aforesaid control means are also designed to set the said valves additionally to a mode in which the first valve is open while the second and third valves are closed, and/or to a mode in which the first and third valves are open, while the second valve is closed.

In one embodiment, the aforesaid valves all extend parallel to each other, the direction of each being substantially orthogonal to the outlet manifold.

According to a further aspect, in one embodiment the said valves are solenoid valves, each provided with a corresponding pair of electrical connecting terminals in the form of flat pins aligned and coplanar with each other, extending in a common plane and connected to an electrical connector including an electrically insulating body of elongate shape, which incorporates within it at least three electrically conducting members having corresponding aligned holes accessible through corresponding apertures in the said insulating body, each of these holes being capable of receiving, with a friction fit, a corresponding electrical terminal of one of the said solenoid valves.

The invention also proposes embodiments in which the ratio between the flow rate of cold water through the second valve and the flow rate of hot water through the first valve, and the ratio between the flow rate of cold water through the third valve and the flow rate of hot water through the first valve take values within predetermined ranges, as described more fully below, in order to provide in the outlet manifold a flow of water whose temperature can be selectively set at one of various predetermined levels.

Further characteristics and advantages of the invention will be made clear by the following detailed description, provided purely by way of example and without restrictive intent, with reference to the attached drawings, in which:

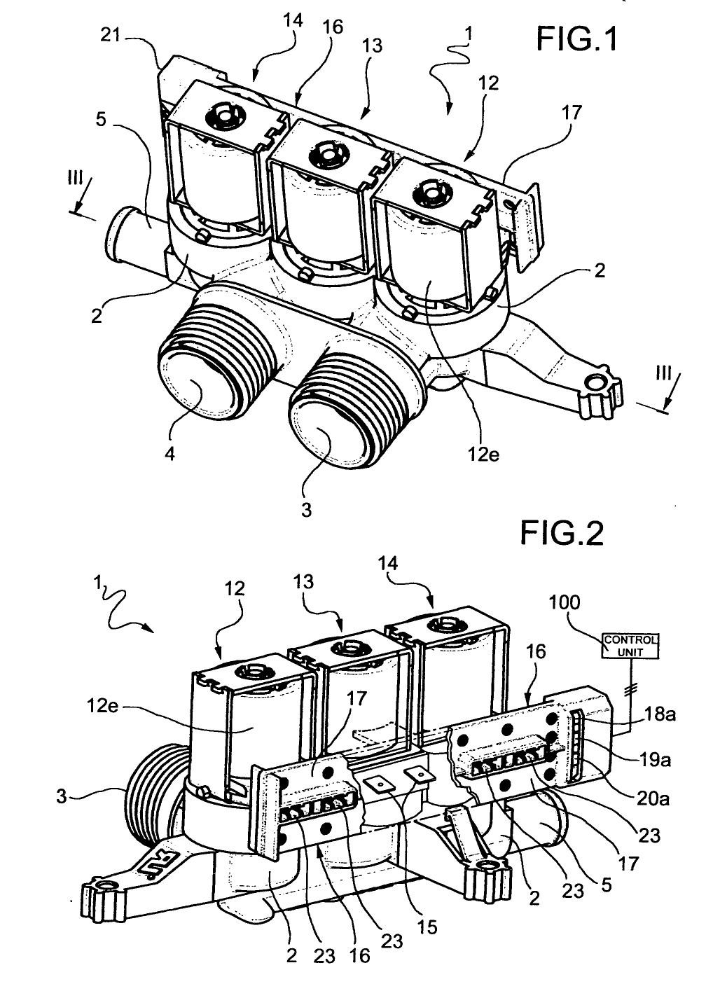

FIG. 1 is a perspective view of a mixer valve for liquids according to the present invention;

FIG. 2 is another perspective view of the mixer valve for liquids of FIG. 1;

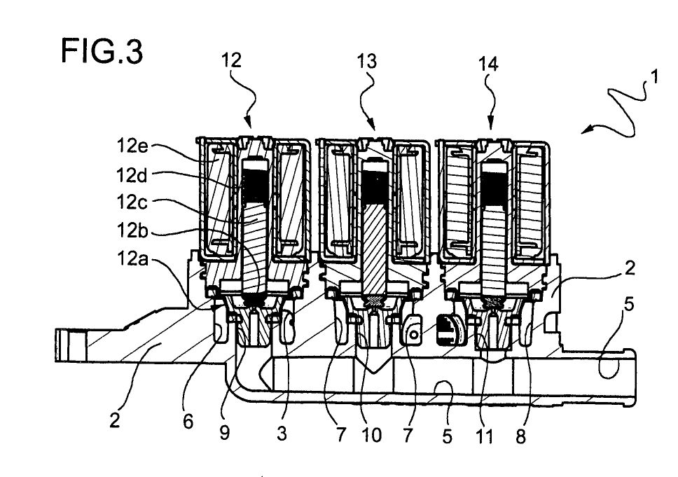

FIG. 3 is a sectional view taken along the line III-III of FIG. 1;

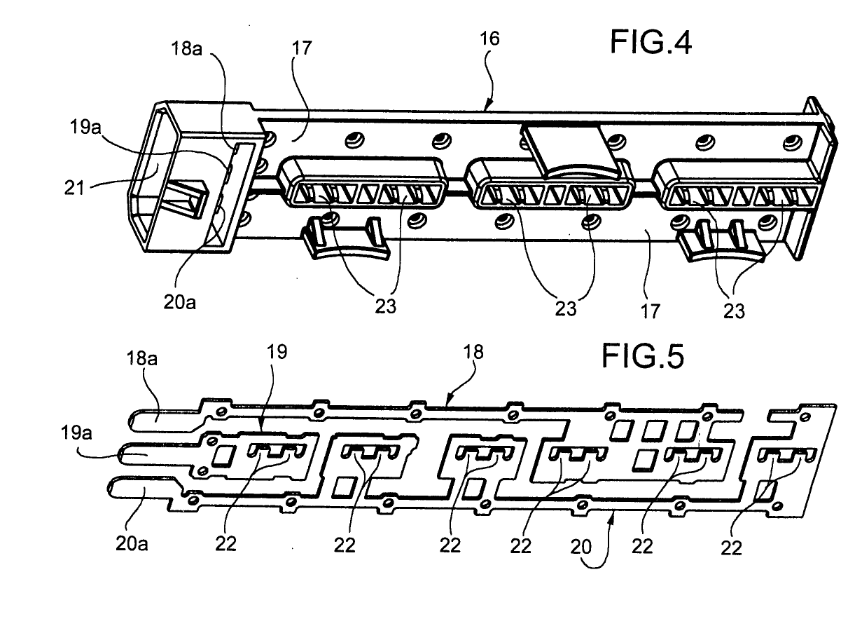

FIG. 4 is a perspective view of an electrical connector for a mixer valve for liquids according to the invention; and

FIG. 5 is a perspective view showing an embodiment of electrically conducting members incorporated into the connector of FIG. 4.

In FIGS. 1 to 3, the number 1 indicates the whole of a mixer valve for liquids according to the present invention. This valve comprises a valve body 2, made from moulded plastics material for example, having a first and a second inlet connector 3, 4 for connection, respectively, to a source of hot water and to a source of cold water which are not shown.

The valve body 2 also forms an outlet manifold, indicated by 5.

With reference to FIG. 3, the valve body 2 has formed within it three chambers 6, 7 and 8, which can be made to communicate with the outlet manifold 5 through corresponding coaxial passages 9, 10 and 11.

The chamber 6 communicates with the inlet connector 3 for hot water, while chambers 7 and 8 both communicate with the inlet connector 4 for cold water.

The inlet 3 for hot water and the inlet 4 for cold water are connected to the chamber 6 and to chambers 7 and 8 respectively through corresponding calibrated passages whose cross section is selected in such a way that the ranges of the corresponding flows of hot and cold water, respectively, are related to each other by ratios whose values lie within predetermined ranges, as explained more fully below.

The communication between the chambers 6, 7 and 8 and the outlet manifold 5 can be controlled by means of corresponding shut-off solenoid valves or on-off solenoid valves 12, 13 and 14, of the normally closed type. These solenoid valves are of a known type, and each has a corresponding main plug 12a, 13a, 14a including a membrane and interacting with a corresponding valve seat formed between the corresponding chamber 6, 7, 8 and the associated outlet passage 9, 10, 11. The main plug of the solenoid valve 12′ has a corresponding axial passage normally shut off by an associated plug 12b positioned above it and carried by a ferromagnetic core 12c on which a helical spring 12d acts inside an associated exciting coil 12e.

The structure of the solenoid valves 13 and 14 is substantially the same as that of the solenoid valve 12.

In the embodiment illustrated by way of example and without restrictive intent, all the solenoid valves 12, 13 and 14 extend parallel to each other with their corresponding directions substantially orthogonal to the outlet manifold 4. However, other relative positions of these solenoid valves are possible.

The solenoid valves 13 and 14 are hydraulically connected in parallel between the second inlet 4, for cold water, and the outlet manifold 5, and, when open, allow the passage of a first and a second flow of cold water respectively from the inlet 4 to the outlet manifold 5, with the respective specified flow rates which can be equal to or different from each other.

In the illustrated embodiment, the solenoid valves 12, 13 and 14 have corresponding pairs of electrical connecting terminals in the form of flat pins 15 (FIG. 2) aligned and coplanar with each other. These connecting terminals of the three solenoid valves 12-14 extend substantially in the same common plane, and are connected to an electrical connector indicated as a whole by 16 in FIGS. 1, 2 and 4.

The connector 16 comprises a body 17 of electrically insulating material, for example moulded plastics, having an elongate shape, and incorporating within it three shaped electrically conducting members 18, 19 and 20. Each of these members has corresponding connecting terminals 18a, 19a and 20a at one end, in the form of flat pins, which are coplanar in the illustrated example of embodiment. These terminals extend outside the insulating body 17, inside a recess 21 (FIG. 4) in this body, for the purpose of connection to wiring for connection to a control unit 100 (FIG. 2) designed to control the solenoid valves 12-14.

The conducting members 18-20 can be incorporated in the insulating casing 17 of the connector 16, for example by overmoulding this casing 17 on to them.

The conducting members 18-20 of the connector 16 have corresponding aligned holes 22 (FIG. 5), facing and accessible through corresponding holes 23 provided in the insulating casing 17 of the connector 16, and each capable of receiving, with a friction fit, a corresponding electrical terminal 15 of an associated solenoid valve 12-14.

The mixer valve 1 is associated with a control unit 100, designed to set the solenoid valves 12-14 selectively to a plurality of different modes, in order to provide a flow of water whose temperature can take a plurality of predetermined levels at the outlet 5 of the valve 1.

The control unit 100 is designed, in particular, to set the solenoid valves 12-14 selectively to one of the following modes:

a) valve 12 for hot water and valve 13 for cold water are open (ON), while valve 14 for cold water is closed (OFF);

b) the first valve 12, the second valve 13 and the third valve 14 are open (ON); and

c) the third valve 14 is open (ON), while the first and second valves 12 and 13 are both closed.

Modes a), b) and c) above provide a flow of water at the outlet manifold 5 having a maximum temperature in mode a), a minimum temperature in mode c), and an intermediate temperature in mode b).

Conveniently, the control unit 100 can be designed to additionally set the valves 12-14 to a further mode in which the first valve 12 is open (ON) while the second and the third valves 13 and 14 are both closed (OFF), and/or to a mode in which the first and third valves 12 and 14 are open (ON), while the second valve 13 is closed (OFF).

In Table 1 below,

| Hot | | | | | |
|---|---|---|---|---|---|
| water | | | | | Outlet |
| valve | Cold water | Cold water | Flow rate | Flow rate | temperatures |
| 12(A) | valve 13(B) | valve 14(C) | ratio B/A | ratio C/A | (° F.) |
| ON | | | | | T1 = 135 |
| ON | ON | | 1.14–2.00 | | T2 = 90 ± 5 |
| ON | | ON | | 1.72–4.48 | T3 = 81 ± 7 |
| ON | ON | ON | 1.14–2.00 | 1.72–4.48 | T4 = 75 ± 5 |
| | | ON | | | T5 = 60 |

the first three columns show the states of the valves 12, 13 and 14 for the five operating modes described above (if the state is not shown, it is considered to be OFF). The fourth and fifth columns show preferred ranges of the ratios B/A and C/A respectively, where A indicates the flow rate of hot water (valve 12), B indicates the flow rate of cold water through valve 13, and C indicates the flow rate of cold water through valve 14. The column farthest to the right of the table shows the corresponding temperature values T1-T5 found in the outlet manifold 5 for the five operating modes defined above.

Tables 2-6 below show the ranges of flow rate for the flows of cold water with respect to the flows of hot water, and the corresponding temperatures that can be obtained in the outlet manifold 5, for another five preferred actuation modes of a mixer valve for liquids according to the invention. In these tables, the significance of the symbols is the same as that described above with reference to Table 1.

TABLE 2

| | Cold | | | | |
|---|---|---|---|---|---|
| Hot water | water | | | | Outlet |
| valve | valve | Cold water | Flow rate | Flow rate | temperatures |
| 12(A) | 13(B) | valve 14(C) | ratio B/A | ratio C/A | (° F.) |
| ON | | | | | T1 = 135 |
| ON | ON | | 0.37–0.66 | | T2 = 110 ± 5 |
| ON | | ON | | 1.14–2.7 | T3 = 90 ± 5 |
| ON | ON | ON | 0.37–0.66 | 1.14–2.7 | T4 = 85 + 5/−8 |
| | | ON | | | T5 = 60 |

TABLE 3

| Hot | Cold | | | | |
|---|---|---|---|---|---|
| water | water | | | | Outlet |
| valve | valve | Cold water | Flow rate | Flow rate | temperatures |
| 12(A) | 13(B) | valve 14(C) | ratio B/A | ratio C/A | (° F.) |
| ON | | | | | T1 = 135 |
| ON | ON | | 0.41–0.66 | | T2 = 110 + 3/−5 |
| ON | | ON | | 1.66–3.33 | T3 = 83 ± 5 |
| ON | ON | ON | 0.41–0.66 | 1.66–3.33 | T4 = 80 ± 5 |
| | | ON | | | T5 = 60 |

TABLE 4

| | Cold | | | | |
|---|---|---|---|---|---|
| Hot water | water | | | | Outlet |
| valve | valve | Cold water | Flow rate | Flow rate | temperatures |
| 12(A) | 13(B) | valve 14(C) | ratio B/A | ratio C/A | (° F.) |
| ON | | | | | T1 = 135 |
| ON | ON | | 0.07–0.25 | | T2 = 125 ± 5 |
| ON | | ON | | 1.12–1.83 | T3 = 92 ± 5 |
| ON | ON | ON | 0.07–0.25 | 1.12–1.83 | T4 = 90 ± 5 |
| | | ON | | | T5 = 60 |

TABLE 5

| Hot | Cold | | | | |
|---|---|---|---|---|---|
| water | water | | | | Outlet |
| valve | valve | Cold water | Flow rate | Flow rate | temperatures |
| 12(A) | 13(B) | valve 14(C) | ratio B/A | ratio C/A | (° F.) |
| ON | | | | | T1 = 135 |
| ON | ON | | 0.07–0.24 | | T2 = 125 + 5/−4 |
| ON | | ON | | 1.9–3.93 | T3 = 81 + 5/−6 |
| ON | ON | ON | 0.07–0.24 | 1.9–3.93 | T4 = 80 ± 5 |
| | | ON | | | T5 = 60 |

TABLE 6

| | Cold | | | | |
|---|---|---|---|---|---|
| Hot water | water | | | | Outlet |
| valve | valve | Cold water | Flow rate | Flow rate | temperatures |
| 12(A) | 13(B) | valve 14(C) | ratio B/A | ratio C/A | (° F.) |
| ON | | | | | T1 = 135 |
| ON | ON | | 0.67–1.13 | | T2 = 110 ± 5 |
| ON | | ON | | 2–4 | T3 = 80 ± 5 |
| ON | ON | ON | 0.67–1.13 | 2–4 | T4 = 75 ± 5 |
| | | ON | | | T5 = 60 |

Clearly, provided that the principle of the invention is retained, the forms of application and the details of construction can be varied widely from what has been described and illustrated purely by way of example and without restrictive intent, without thereby departing from the scope of protection of the invention as defined by the attached claims.

1. Mixer valve for liquids, comprising
a valve body having
at least a first and a second inlet for connection to a source of hot water and a source of cold water respectively, and
an outlet manifold;
a first, a second and a third electrically operated shut-off valve, of which
the first valve is interposed between the first inlet and the outlet manifold; and
the second and third valves are hydraulically connected in parallel between the second inlet and the outlet manifold so that, when they are open, they allow the passage of a first and second flow of cold water, respectively, from the second inlet to the outlet manifold, the first flow of cold water having a flow rate less than or equal to the flow rate of the second flow of cold water; and
control means for setting the said valves selectively to one of the following modes:
a) the first and second valves are open, while the third valve is closed;
b) the first, second and third valves are open simultaneously; and
c) the third valve is open, while the first and second valves are closed.

2. Mixer valve for liquids according to claim 1, in which the control means are designed to additionally set the said valves to a mode in which the first valve is open, while the second and third valves are closed.

3. Mixer valve for liquids according to claim 1, in which the control means are designed to additionally set the said valves to a mode in which the first and third valves are open, while the second valve is closed.

4. Mixer valve for liquids according to claim 1, in which the ratio between the flow rate of the flow of cold water associated with the second valve and the flow rate of the flow of hot water associated with the first valve is in the range from 1.14 to 2.00, and the ratio between the flow rate of the flow of cold water associated with the third valve and the flow rate of the flow of hot water associated with the first valve is in the range from 1.72 to 4.48.

5. Mixer valve for liquids according to claim 1, in which the ratio between the flow rate of the flow of cold water associated with the second valve and the flow rate of the flow of hot water associated with the first valve is in the range from 0.37 to 0.66, and the ratio between the flow rate of the flow of cold water associated with the third valve and the flow rate of the flow of hot water associated with the first valve is in the range from 1.14 to 2.7.

6. Mixer valve for liquids according to claim 1, in which the ratio between the flow rate of the flow of cold water associated with the second valve and the flow rate of the flow of hot water associated with the first valve is in the range from 0.41 to 0.66, and the ratio between the flow rate of the flow of cold water associated with the third valve and the flow rate of the flow of hot water associated with the first valve is in the range from 1.66 to 3.33.

7. Mixer valve for liquids according to claim 1, in which the ratio between the flow rate of the flow of cold water associated with the second valve and the flow rate of the flow of hot water associated with the first valve is in the range from 0.07 to 0.25, and the ratio between the flow rate of the flow of cold water associated with the third valve and the flow rate of the flow of hot water associated with the first valve is in the range from 1.12 to 1.83.

8. Mixer valve for liquids according to claim 1, in which the ratio between the flow rate of the flow of cold water associated with the second valve and the flow rate of the flow of hot water associated with the first valve is in the range from 0.07 to 0.24, and the ratio between the flow rate of the flow of cold water associated with the third valve and the flow rate of the flow of hot water associated with the first valve is in the range from 1.9 to 3.93.

9. Mixer valve for liquids according to claim 1, in which the ratio between the flow rate of the flow of cold water associated with the second valve and the flow rate of the flow of hot water associated with the first valve is in the range from 0.67 to 1.13, and the ratio between the flow rate of the flow of cold water associated with the third valve and the flow rate of the flow of hot water associated with the first valve is in the range from 2.00 to 4.00.

10. Mixer valve for liquids according to claim 1, in which the said valves extend parallel to each other in corresponding directions substantially orthogonal to the outlet manifold.

11. Mixer valve for liquids according to claim 10, in which the said valves are solenoid valves, each provided with a corresponding pair of electrical connecting terminals in the form of flat pins aligned and coplanar with each other, extending in the same common plane and connected to an electrical connector including an electrically insulating body of elongate shape, which incorporates within it at least three electrically conducting members having corresponding aligned holes accessible through corresponding apertures in the said insulating body, each of these holes being capable of receiving, with a friction fit, a corresponding electrical terminal of one of the said solenoid valves.

12. Mixer valve for liquids according to claim 11, in which the said conducting members have corresponding end connecting terminals which emerge from the insulating body, for the connection of the said solenoid valves to the associated control means.
